(19) United States
(12) Patent Application Publication
(10) Pub. No.: US 2017/0158849 A1
(43) Pub. Date: Jun. 8, 2017

(54) RUBBER COMPOSITION COMPRISING AN ELASTOMER CONTAINING METHACRYLATE UNITS

(71) Applicants: COMPAGNIE GENERALE DES ETABLISSEMENTS MICHELIN, clermont-ferrand (FR); MICHELIN RECHERCHE ET TECHNIQUE, S.A., Granges-Paccot (CH)

(72) Inventors: Nathalie COSTE, Clermont-Ferrand Cedex 9 (FR); Régis SCHACH, Clermont-Ferrand Cedex 9 (FR); Rachid MATMOUR, Clermont-Ferrand Cedex 9 (FR)

(21) Appl. No.: 15/323,313

(22) PCT Filed: Jun. 25, 2015
(86) PCT No.: PCT/EP2015/064361

§ 371 Date: Dec. 30, 2016

(30) Foreign Application Priority Data
Jul. 1, 2014 (FR) 1456241

(51) Int. Cl. C08L 33/10; C08J 3/18; C08J 3/24; C08K 13/02; C08J 3/20

(52) U.S. Cl. CPC C08L 33/10; C08K 13/02; C08J 3/20; C08J 3/24; C08J 3/18; C08L 2312/00; C08J 2333/10; C08J 2409/06

(57) ABSTRACT

A rubber composition based on a reinforcing filler, an elastomer matrix that is reactive with respect to the crosslinking system, wherein the elastomer matrix comprises an elastomer A comprising monomer units of a first methacrylic acid ester which represent at least 20 mol % of the monomer units of the elastomer A, and a crosslinking system is provided. The rubber composition makes it possible to improve the wet grip of tires whose tread consists of the rubber composition.

This application is a 371 national phase entry of PCT/EP2015/064361, filed 25 Jun. 2015, which claims benefit of French Patent Application No. 1456241, filed 1 Jul. 2014, the entire contents of which are incorporated herein by reference for all purposes.

### BACKGROUND

1. Technical Field

The field of the present invention is that of rubber compositions reinforced by a reinforcing filler, especially used in the manufacture of tires for vehicles.

2. Related Art

One of the requirements needed for a tire is to provide optimal grip on the road, especially on wet ground. One way of giving the tire increased grip on wet ground is to use a rubber composition in its tread, which composition has a broad hysteresis potential.

But at the same time, the tire tread must also minimize its contribution to the rolling resistance of the tire, that is to say have the lowest possible hysteresis. Thus, the rubber composition of the tread must satisfy two conflicting requirements, namely having a maximum hysteresis potential in order to satisfy the requirement of grip and having a hysteresis that is as low as possible in order to satisfy the requirement of rolling resistance.

Satisfying both the requirement of grip, especially on wet ground, and of rolling resistance remains a constant concern of tire manufacturers.

In order to reduce the rolling resistance of a tire tread, it has been proposed to introduce, into the constituent rubber composition of the tread, elastomers comprising methacrylic ester monomer units bearing a function that interacts with silica such as an alcohol function. The contents by weight of the monomer units of the methacrylic acid ester in the elastomer are generally less than 20% of the weight of the elastomer, which represents a molar content of the monomer units of the methacrylic acid ester much lower than 20%, considering the respective molar masses of the constituent monomer units of the elastomer. Reference may be made for example to the publication of patent application EP 1 308 318.

### SUMMARY

The applicants have discovered during their research that introducing certain elastomers comprising methacrylic acid ester monomer units in a constituent rubber composition of a tire tread makes it possible to significantly improve the wet grip performance.

Thus, a first subject of the invention is a rubber composition based on a reinforcing filler, a crosslinking system, an elastomer matrix that is reactive with respect to the crosslinking system, which elastomer matrix comprises an elastomer A comprising monomer units of a first methacrylic acid ester which represent at least 20 mol % of the monomer units of the elastomer A, with the proviso that if the elastomer A is a polymer of several monomers, the elastomer A is a statistical copolymer.

Another subject of the invention is a semi-finished product made of rubber, especially a tread, comprising a rubber composition in accordance with the invention.

Another subject of the invention is a tire comprising a semi-finished product made of rubber, preferentially a tread, which is in accordance with the invention. Such a tire has an improved wet grip.

The invention also relates to a process for manufacturing the rubber composition in accordance with the invention.

The invention also relates to a process for manufacturing the tire in accordance with the invention.

### DETAILED DESCRIPTION

Any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

The expression composition “based on” should be understood to mean a composition comprising the mixture and/or the reaction product of the various constituents used, some of these base constituents being capable of reacting, or intended to react, with one another, at least in part, during the various phases of manufacture of the composition, in particular during the crosslinking or vulcanization thereof.

All the percentages are percentages by weight unless otherwise indicated.

The abbreviation “phr” means parts by weight per hundred parts of elastomer present in the elastomer matrix.

“Elastomer matrix” is understood to mean to mean all the elastomers present in the rubber composition.

The elastomer A which forms all or part of the elastomer matrix has the essential feature of comprising monomer units of a (one or more) first methacrylic acid ester which represent at least 20 mol % of the monomer units of the elastomer A, preferably at least 30 mol % of the monomer units of the elastomer A, more preferentially at least 50 mol % of the monomer units of the elastomer A. These preferential ranges may apply to any one of the embodiments of the invention.

According to one embodiment of the invention, the first methacrylic acid ester is an aliphatic compound.

According to a particular embodiment of the invention, the first methacrylic acid ester is different from a methacrylic acid ester comprising one or more epoxide functions. This particular embodiment implies that the elastomer A may contain monomer units of a methacrylic acid ester comprising one or more epoxide functions, with the proviso that it also contains monomer units of another methacrylic acid ester, in this particular case the first methacrylic acid ester, in molar contents in accordance with embodiments of the invention.

According to one preferential embodiment of the invention, the first methacrylic acid ester corresponds to the formula (I) where Z is a carbon-based chain comprising at least 2 carbon atoms, optionally substituted and optionally interrupted by one or more heteroatoms. When the carbon-based chain Z comprises at least 2 carbon atoms, the gain in wet grip is even better. More preferentially, the carbon-based chain Z comprises 2 to 20 carbon atoms. Even more preferentially, the carbon-based chain Z is a hydrocarbon-based chain, that is to say consisting exclusively of carbon and hydrogen atoms.

CH₂═C(CH₃)—COO—Z (I)

Very advantageously, Z is an alkyl radical.

Better still, the first methacrylic acid ester corresponds to the formula selected from the group consisting of the formulae (Ia), (Ib), (Ic) and (Id):

CH₂═C(CH₃)—COO—Z(a) (Ia)

CH₂═C(CH₃)—COO—Z(b) (Ib)

CH₂═C(CH₃)—COO—Z(c) (Ic)

CH₂═C(CH₃)—COO—Z(d) (Id)
where:
Z(a) is the 2-ethylhexyl radical,
Z(b) is the n-octyl radical,
Z(c) is the isodecyl radical,
Z(d) is the n-tridecyl radical.

The formulae (Ia), (Ib), (Ic) and (Id) of the first methacrylic acid ester may be applied to any one of the embodiments of the invention.

When the elastomer A is a polymer of several monomers, the elastomer A is a statistical copolymer. For example, when the elastomer A comprises n-octyl methacrylate and 2-ethylhexyl methacrylate monomer units, the monomer units are distributed randomly in the polymer chain.

According to one embodiment of the invention, the elastomer A is an elastomer obtained by radical polymerization, in particular in bulk, in solution or in a dispersed medium, especially in emulsion, dispersion or suspension. Radical polymerization, especially in bulk, in solution or in a dispersed medium, is a process well known to those skilled in the art of polymer synthesis. The choice of one or other of these three processes may be guided, for example, by the reactivity of the monomers to be polymerized, the polymerization kinetics or the exothermicity of the polymerization reaction. For the choice of the polymerization process, reference may, for example, be made to the following publications: Macromolecules, 1998, 31, 2822-2827; Macromolecules, 2006, 39, 923-930); J. Am. Chem. Soc. 1951, 73, 5736. This embodiment may be applied to any one of the embodiments of the invention.

The elastomer matrix is reactive with respect to the crosslinking system. This essential feature means that the elastomer matrix has sites that are reactive with respect to the crosslinking system. In other words, the elastomer matrix comprises at least one elastomer that has sites that are reactive with respect to the crosslinking system.

According to an embodiment of the invention, the sites of the elastomer matrix that are reactive with respect to the crosslinking system are capable of reacting with the crosslinking system by forming covalent bonds. This embodiment may be applied to any one of the embodiments of the invention.

According to one embodiment of the invention, the elastomer matrix comprises monomer units that are reactive with respect to the crosslinking system. In other words, the reactive sites of the elastomer matrix are monomer units of the elastomer matrix. According to this embodiment, the elastomer matrix reacts with the crosslinking system by means of monomer units present in at least one of the elastomers of the elastomer matrix and that are reactive with respect to the crosslinking system. The elastomer for which the monomer units are reactive with respect to the crosslinking system may be the elastomer A. In the case where the elastomer A does not have monomer units that are reactive with respect to the crosslinking system, the elastomer matrix comprises a second elastomer B that has monomer units that are reactive with respect to the crosslinking system.

According to one embodiment of the invention, the content of elastomer A in the elastomer matrix is at least 20 phr, preferentially at least 40 phr, more preferentially at least 50 phr. This embodiment, whether in its preferential forms or not, may apply to any one of the embodiments of the invention.

According to a first variant of the invention, the elastomer matrix comprises a (one or more) second elastomer, elastomer B, which comprises monomer units that are reactive with respect to the crosslinking system.

Preferentially, the elastomer B is a diene elastomer.

A “diene” elastomer (or rubber) should be understood, in a known way, as an (or several) elastomer consisting, at least in part (i.e., a homopolymer or a copolymer), of diene monomer units (monomers bearing two conjugated or unconjugated carbon-carbon double bonds).

These diene elastomers can be classified into two categories: “essentially unsaturated” or “essentially saturated”. Generally, “essentially unsaturated” is understood to mean a diene elastomer derived at least in part from conjugated diene monomers having a content of units of diene origin (conjugated dienes) which is greater than 15% (mol %); thus, diene elastomers, such as butyl rubbers or copolymers of dienes and α-olefins of EPDM type, do not fall under the preceding definition and may especially be described as “essentially saturated” diene elastomers (low or very low content, always less than 15%, of units of diene origin). In the category of “essentially unsaturated” diene elastomers, a “highly unsaturated” diene elastomer is intended in particular to mean a diene elastomer having a content of units of diene origin (conjugated dienes) which is greater than 50%.

Given these definitions, “diene elastomer capable of being used in the compositions in accordance with embodiments of the invention” is intended more particularly to mean:

(a)—any homopolymer of a conjugated diene monomer, especially any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and an α-olefin having from 3 to 6 carbon atoms with an unconjugated diene monomer having from 6 to 12 carbon atoms, such as, for example, the elastomers obtained from ethylene and propylene with an unconjugated diene monomer of the abovementioned type, such as, especially, 1,4-hexadiene, ethylidenenorbornene or dicyclopentadiene;
(d)—an unsaturated olefinic copolymer, the chain of which comprises at least olefinic monomer units, that is to say units derived from the insertion of at least one α-olefin or ethylene, and diene monomer units derived from at least one conjugated diene;
(e) a copolymer of isobutene and of isoprene (butyl rubber) and also the halogenated versions, in particular chlorinated or brominated versions, of this type of copolymer.

Although it applies to any type of diene elastomer, those skilled in the art of tires will understand that embodiments of the present invention are preferably employed with essentially unsaturated diene elastomers, in particular of the above type (a) or (b).

In the case of copolymers of type (b), the latter contain from 20 to 99% by weight of diene units and from 1 to 80% by weight of vinylaromatic units.

By way of conjugated dienes, the following are especially suitable: 1,3-butadiene, 2-methyl-1,3-butadiene, 2,3-di(C1-C5 alkyl)-1,3-butadienes such as for example 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene, 2,4-hexadiene.

The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

More preferentially, the elastomer B is an essentially unsaturated diene elastomer selected from the group consisting of polybutadienes, polyisoprenes, butadiene copolymers, isoprene copolymers and mixtures of these elastomers. The following are very particularly suitable as diene elastomer: a polybutadiene (BR), a copolymer of 1,3-butadiene and styrene (SBR), a natural rubber (NR) or a synthetic polyisoprene (IR) preferentially with a molar content of cis-1,4-bonds of greater than 90%.

According to one embodiment of the first variant of the invention, the elastomer matrix consists of the elastomer A and of the elastomer B.

According to one embodiment of the first variant of the invention, the monomer units of the first methacrylic acid ester present in the elastomer A represent 100 mol % of the monomer units of the elastomer A. In the case where the first methacrylic acid ester is a mixture of methacrylic acid esters, the elastomer A is a copolymer of these methacrylic acid esters. In the case where the first methacrylic acid ester consists of a single methacrylic acid ester, the elastomer A is a homopolymer of the first methacrylic acid ester. Advantageously, the elastomer A is a homopolymer of 2-ethylhexyl methacrylate, a homopolymer of n-octyl methacrylate, a homopolymer of isodecyl methacrylate or a homopolymer of n-tridecyl methacrylate. This embodiment may be applied to any one of the embodiments of this first variant of the invention.

According to one particular embodiment of the first variant of the invention, the elastomer A may comprise, in addition to the monomer units of the first methacrylic acid ester, vinylaromatic units, especially styrene monomer units.

According to a second variant of the invention, the elastomer A comprises monomer units that are reactive with respect to the crosslinking system.

Preferably, the elastomer A comprises monomer units of a (one or more) second monomer, which monomer units are reactive with respect to the crosslinking system. The proportion of monomer units of the second monomer in the elastomer A is adjusted by those skilled in the art as a function of the reactivity of the monomer units of the second monomer with respect to the crosslinking system and also of the targeted degree of crosslinking of the rubber composition.

The monomer units of the second monomer are suitably chosen by those skilled in the art as a function of the reactivity of the crosslinking system. When the crosslinking system comprises a compound having at least two nucleophilic groups, the monomer units of the second monomer are electrophilic, that is to say the monomer units of the second monomer bear an electrophilic group; and vice versa when the crosslinking system comprises a compound having at least two electrophilic groups, the monomer units of the second monomer are preferably nucleophilic, that is to say the monomer units of the second monomer bear a nucleophilic group. The imide group, the epoxy group or the carbonate group are suitable, for example, as the electrophilic group; as nucleophilic group, mention may be made of the NH₂ group or the OH group, in particular that of alcohols or carboxylic acids. When the crosslinking system is based on sulphur, on peroxide or on bismaleimide, the monomer units of the second monomer may contain at least one carbon-carbon double bond that reacts in particular via a radical pathway with the crosslinking system. Thus, the monomer units of the second monomer contain for example at least one NH₂, OH, imide, carbonate or epoxy group or a carbon-carbon double bond.

More preferentially, the elastomer A is preferably a copolymer of the first methacrylic acid ester and of the second monomer. In other words, the monomer units that constitute the elastomer A consist of the monomer units of the first methacrylic acid ester and the monomer units of the second monomer.

As second monomer having monomer units containing at least one carbon-carbon double bond, mention may be made of 1,3-dienes, especially 1,3-butadiene and isoprene. Typically, the proportion of 1,3-diene monomer units in the elastomer A is at least 2 moles per 100 moles of monomer units of the elastomer A, for example it varies within a range extending from 2 to 80 moles per 100 moles of monomer units of the elastomer A.

As second monomer, mention may also be made of the methacrylic acid esters, which esters bear a site that is reactive with respect to the crosslinking system within their monomer unit. Mention may be made of those having at least one carbon-carbon double bond such as dicyclopentadienyloxyethyl methacrylate. Mention may also be made of the esters that bear an imide, carbonate or epoxy group such as N-hydroxysuccinimide methacrylate, glycerol carbonate methacrylate and glycidyl methacrylate. Typically, the proportion of monomer units of these methacrylic acid esters bearing a site that is reactive with respect to the crosslinking system is at least 0.2 mole per 100 moles of monomer units, more preferentially between 0.2 and 10 moles per 100 moles of monomer units of the elastomer A. This content is adjusted by those skilled in the art as a function of the reactivity of the monomer units of the second monomer with respect to the crosslinking system and also of the targeted degree of crosslinking.

According to one particular embodiment of the second variant of the invention, the elastomer A may comprise, in addition to the monomer units of the second monomer, vinylaromatic units, especially styrene monomer units.

In addition to the elastomer A that is reactive with respect to the crosslinking system, the elastomer matrix may comprise one (one or more) other elastomer C. The elastomer C may be the elastomer B as defined in the first variant of the invention.

According to any one of the embodiments of the second variant of the invention, the content of elastomer A is preferably greater than 50 phr, more preferably greater than 80 phr.

An essential feature of the rubber composition in accordance with embodiments of the invention is that it comprises a crosslinking system.

The choice of the crosslinking system is made as a function of the chemical structure of the reactive sites borne by the elastomer matrix, as mentioned above. The content of the compound or compounds that constitute the crosslinking system introduced into the rubber composition is adjusted by those skilled in the art as a function of the targeted degree of crosslinking of the rubber composition and of the chemical nature of the crosslinking system. This crosslinking content is defined according to the desired rigidity of the rubber composition in the crosslinked state, this rigidity varying depending on the envisaged application of the rubber composition.

For example, when the crosslinking system is a system based on sulphur, it being possible for the sulphur to be provided by a sulphur donor, the crosslinking system is preferably a vulcanization system, that is to say a system based on sulphur (or on a sulphur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine), or else known vulcanization retarders, are added to this basic vulcanization system, being incorporated during the first non-productive phase and/or during the productive phase, as described subsequently. Mention may be made, as (primary or secondary) vulcanization accelerator, of any compound capable of acting as accelerator for the vulcanization of diene elastomers in the presence of sulphur, especially accelerators of the thiazole type, and also their derivatives, and accelerators of sulphenamide, thiuram, dithiocarbamate, dithiophosphate, thiourea and xanthate types. The sulphur is used at a preferential content of between 0.5 and 12 phr, in particular between 1 and 10 phr. The primary vulcanization accelerator is used in the rubber composition at a preferential content of between 0.5 and 10 phr, more preferentially of between 0.5 and 5.0 phr.

When the crosslinking system comprises a compound having at least two nucleophilic or electrophilic reactive groups as defined above, the amount of crosslinking system introduced into the rubber composition is linked to the number of moles of reactive groups of this compound with respect to the number of reactive sites of the elastomer matrix. The amount of this compound introduced into the rubber composition preferably varies from 0.05 to 5, more preferentially from 0.05 to 2 molar equivalents of nucleophilic or electrophilic reactive groups of this compound per one mole of reactive site of the elastomer matrix. These preferential ranges may be applied to any one of the embodiments of the second variant of the invention.

In the choice of the compound belonging to the crosslinking system having at least two nucleophilic or electrophilic reactive groups depending on the reactivity of the elastomer A, reference may be made to the article “Chemical modification of polymers Part II. Attachment of carboxylic acid containing molecules to polymers” by J. C. Soutif and J. C. Brosse in Reactive Polymers, 12 (1990) 133-153 and also to the article “Reactive Applications of Cyclic Alkylene Carbonates” by John H. Clements in Industrial & Engineering Chemistry Research 2003 42, 4, 663-674). The first article presents functions that are reactive with epoxy groups, the second presents functions that are reactive with carbonates, especially acids, alcohols and amines.

As a compound belonging to the crosslinking system that has at least two groups that are reactive with respect to the elastomer A, mention may be made of polyacids, in particular diacids, or the dehydrated forms thereof, namely anhydrides, and polyamines, in particular diamines. For example, as polyacids that are commercially available and useful for the requirements of embodiments of the invention, mention may be made of oxalic acid, succinic acid, adipic acid, sebacic acid, dodecanedioic acid, terephthalic acid, trimesic acid and 3,4-bis(carboxymethyl)cyclopentanecarboxylic acid. As polyamines, mention may be made, for example, of 1,6-diaminohexane, 1,8-diaminooctane and the family of “Jeffamines” from Huntsman, among which those skilled in the art will know how to choose the most suitable polyamine with respect to the expected properties of the crosslinked rubber composition.

The rubber composition of the tread in accordance with embodiments of the invention comprises any type of filler referred to as reinforcing, known for its abilities to reinforce a rubber composition which can be used for the manufacture of tires, for example a reinforcing organic filler, such as carbon black, a reinforcing inorganic filler, such as silica, or else a mixture of these two types of filler.

Such a reinforcing filler typically consists of nanoparticles, the (weight-)average size of which is less than a micrometre, generally less than 500 nm, usually between 20 and 200 nm, in particular and more preferentially between 20 and 150 nm.

All carbon blacks, especially the blacks conventionally used in tire treads, are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks. These carbon blacks can be used in the isolated state, as available commercially, or in any other form, for example as support for some of the rubber additives used.

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferentially silica (SiO₂), are especially suitable as reinforcing inorganic fillers. The silica used can be any reinforcing silica known to those skilled in the art, especially any precipitated or fumed silica exhibiting a BET surface area and a CTAB specific surface area both of less than 450 m²/g.

As reinforcing inorganic filler, mention will also be made of mineral fillers of the aluminous type, in particular alumina (Al₂O₃) or aluminium (oxide)hydroxides, or else reinforcing titanium oxides, for example described in U.S. Pat. No. 6,610,261 and U.S. Pat. No. 6,747,087.

The physical state in which the reinforcing inorganic filler is provided is unimportant, whether it is in the form of a powder, microbeads, granules or also beads. Of course, reinforcing inorganic filler is also understood to mean mixtures of different reinforcing inorganic fillers, in particular of highly dispersible silicas as described above.

Those skilled in the art will understand that use might be made, as filler equivalent to the reinforcing inorganic filler described in the present paragraph, of a reinforcing filler of another nature, especially organic, such as carbon black, provided that this reinforcing filler is covered with an inorganic layer, such as silica, or else comprises, at its surface, functional sites, especially hydroxyl sites, requiring the use of a coupling agent in order to establish the bond between the filler and the elastomer. By way of example, mention may be made, for example, of carbon blacks for tires, such as described, for example, in patent documents WO 96/37547 and WO 99/28380.

Preferably, the content of reinforcing filler is between 40 and 200 phr. Below 40 phr, the reinforcement of the rubber composition is insufficient to provide an adequate level of cohesion or wear resistance of the rubber composition. More preferentially, the content of reinforcing filler is at least 50 phr. Above 200 phr, there is a risk of increasing the hysteresis and thus the rolling resistance of the tires. For this reason, the content of reinforcing inorganic filler is advantageously in a range extending from 50 to 200 phr, better still from 50 to 160 phr. These preferential ranges of content of reinforcing filler may apply to any one of the embodiments of the invention.

According to one embodiment of the invention, the reinforcing filler comprises a carbon black.

According to another embodiment of the invention, the reinforcing filler comprises a reinforcing inorganic filler, preferentially a silica.

According to one preferential embodiment of the invention, the reinforcing filler consists predominantly by weight of a reinforcing inorganic filler, which means that the reinforcing inorganic filler constitutes more than 50% by weight of the reinforcing filler of the rubber composition of the tread in accordance with embodiments of the invention. This reinforcing inorganic filler is preferentially a silica. This embodiment, according to which the silica constitutes more than 50% by weight of the reinforcing filler of the rubber composition, may apply to any one of the embodiments of the invention.

According to one particular embodiment where the reinforcing inorganic filler such as silica represents more than 50% by weight of the reinforcing filler, carbon black is used preferably at a content of less than 20 phr, more preferentially less than 10 phr (for example between 0.5 and 20 phr, especially between 2 and 10 phr), more preferentially still less than 5 phr. Within the intervals indicated, the colouring properties (black pigmenting agent) and UV-stabilizing properties of the carbon blacks are beneficial, without, moreover, adversely affecting the typical performance properties contributed by the reinforcing inorganic filler.

In order to couple the reinforcing inorganic filler to at least one of the elastomers that constitute the elastomer matrix of the rubber composition, especially in the case where the inorganic filler constitutes more than 50% by weight of the reinforcing filler of the rubber composition, use is generally made, in a well known manner, of a coupling agent (or bonding agent). The expression “coupling agent” is understood more specifically to mean an agent capable of establishing a sufficient bond of chemical and/or physical nature between the filler in question and the elastomer, while facilitating the dispersion of this filler within the elastomer matrix.

This at least bifunctional agent is intended to ensure a sufficient connection, of chemical and/or physical nature, between the inorganic filler (surface of its particles) and the elastomer. Use is made, in particular, of organosilanes, especially alkoxysilane polysulphides or mercaptosilanes, or else polyorganosiloxanes bearing functions capable of bonding physically and/or chemically to the inorganic filler and functions capable of bonding physically and/or chemically to the elastomer, for example by means of a sulphur atom. Silica/elastomer bonding agents, especially, have been described in a large number of documents, the best known being bifunctional alkoxysilanes such as alkoxysilane polysulphides. Use is made especially of silane polysulphides, referred to as “symmetrical” or “asymmetrical” depending on their specific structure, such as described, for example, in applications WO 03/002648 (or US 2005/016651) and WO 03/002649 (or US 2005/016650).

Mention will especially be made, as coupling agent other than alkoxysilane polysulphide, of bifunctional POSs (polyorganosiloxanes), or else of hydroxysilane polysulphides as described in patent applications WO 02/30939 (or U.S. Pat. No. 6,774,255) and WO 02/31041 (or US 2004/051210), or else of silanes or POSs bearing azodicarbonyl functional groups, as described for example in patent applications WO 2006/125532, WO 2006/125533 and WO 2006/125534.

The content of coupling agent, whether it is a single compound or a mixture of compounds, is advantageously less than 20 phr, it being understood that it is generally desirable to use as little as possible thereof. Typically, the content of coupling agent represents from 0.5% to 15% by weight relative to the amount of inorganic filler. Its content is preferentially between 0.5 and 12 phr, more preferentially within a range extending from 3 to 10 phr. This content is easily adjusted by those skilled in the art depending on the content of inorganic filler used in the composition.

The rubber composition in accordance with embodiments of the invention may also contain coupling activators, agents for covering the inorganic fillers or more generally processing aids capable, in a known manner, by virtue of an improvement in the dispersion of the filler in the rubber matrix and of a lowering of the viscosity of the rubber composition, of improving its ease of processing in the uncured state, these agents being, for example, hydrolysable silanes, such as alkylalkoxysilanes, polyols, polyethers, primary, secondary or tertiary amines, or hydroxylated or hydrolysable polyorganosiloxanes.

The rubber composition in accordance with embodiments of the invention may also likewise comprise all or some of the usual additives customarily used in the rubber compositions intended for the manufacture of tires, such as, for example, plasticizers, pigments, protective agents such as antiozone waxes, chemical antiozonants, antioxidants, antifatigue agents and mixtures of such compounds.

The rubber composition in accordance with embodiments of the invention may be manufactured in appropriate mixers, generally using two successive phases of preparation well known to those skilled in the art: a first phase of thermomechanical working or kneading (“non-productive” phase) at high temperature, up to a maximum temperature of between 110° C. and 190° C., preferably between 120° C. and 180° C., followed by a second phase of mechanical working (“productive” phase) up to a lower temperature, typically below 110° C., for example between 40° C. and 100° C., during which finishing phase the crosslinking system is incorporated.

The rubber composition in accordance with embodiments of the invention may be prepared according to a process which comprises the following stages:
thermomechanically kneading the elastomer matrix, the reinforcing filler, where appropriate the coupling agent, where appropriate the plasticizing system, and the other additives of the rubber composition with the exception of the crosslinking system, until a maximum temperature of between 110° C. and 190° C. is reached;
cooling the combined mixture to a temperature of less than 100° C.;
subsequently incorporating the crosslinking system;
kneading everything up to a maximum temperature of less than 110° C., in order to obtain a rubber composition.

After incorporating all the ingredients of the rubber composition, the final composition thus obtained is then calendered, for example in the form of a sheet or slab, in particular for laboratory characterization, or else extruded, in order to form, for example, a rubber profiled element that is used as rubbery component, in particular for the manufacture of the tire. The rubber composition in accordance with embodiments of the invention may be used in calendering form in a tire. The calendering or the extrudate formed from the rubber composition wholly or partly forms a semi-finished product, in particular of a tire.

Thus, according to one particular embodiment of the invention, the rubber composition, that may be either in the uncured state (before crosslinking or vulcanization), or in the cured state (after crosslinking or vulcanization), is in a tire, for example in a tire tread.

The crosslinking (or curing), where appropriate the vulcanization, is carried out in a known manner at a temperature generally of between 130° C. and 200° C., for a sufficient time which may vary, for example, between 5 and 120 min, depending especially on the curing temperature, on the crosslinking system adopted and on the crosslinking kinetics of the composition in question.

The tire tread, another subject of the invention, has the essential feature of being wholly or partly formed from the rubber composition in accordance with embodiments of the invention. The tread may be manufactured according to the process described above which comprises an additional step of calendering or extruding the rubber composition.

The invention also relates to the tread described above, both in the uncured state (that is to say, before curing) and in the cured state (that is to say, after crosslinking or vulcanization).

The invention also relates to the tire comprising a semi-finished article in accordance with embodiments of the invention, which tire is both in the uncured state and in the cured state, the semi-finished article preferably being a tread.

The tire in accordance with embodiments of the invention may be prepared by the process that comprises the following steps:
thermomechanically kneading the elastomer matrix, the reinforcing filler, where appropriate the coupling agent, where appropriate the plasticizing system, and the other additives of the rubber composition with the exception of the crosslinking system, until a maximum temperature of between 110° C. and 190° C. is reached;
cooling the combined mixture to a temperature of less than 100° C.;
subsequently incorporating the crosslinking system;
kneading everything up to a maximum temperature of less than 110° C., in order to obtain a rubber composition,
calendering or extruding the rubber composition.

### Exemplary Embodiments

### 1—Measurements and Tests Used:

### 1-1 Determination of the Glass Transition Temperature of the Elastomers:

The glass transition temperatures Tg of the polymers are measured by means of a differential calorimeter (differential scanning calorimeter) according to the standard ASTM D3418-08.

### 1-2 Determination of the Microstructure of the Elastomers by NMR Analysis:

The determination of the content of methacrylate units is carried out by ¹H NMR analysis. The spectra are acquired on a BRUKER Avance 500 MHz spectrometer equipped with a BBFO z-grad 5 mm “broad band” cryoprobe for the soluble samples and with an HRMAS 4 mm ¹H/¹³C probe for the insoluble crosslinked samples.

The quantitative ¹H NMR experiment uses a 30° single pulse sequence and a repetition time of 5 seconds between each acquisition. The samples are dissolved in deuterated chloroform.

The edited HSQC ¹J ¹H/¹³C 2D NMR correlation spectrum makes it possible to verify the structure of the methacrylate units owing to the chemical shifts of the carbon atoms and protons. HMBC ³J ¹H/¹³C long-range correlation spectra make it possible to consolidate this information. 1D ¹³C NMR spectra make it possible to verify the chaining of the units (diads and triads) and to attain the tacticity of the copolymers.

The chemical shifts are calibrated with respect to the protonated impurity of the chloroform with respect to tetramethylsilane, TMS (δppm ¹H and δppm ¹³C at 0 ppm).

### 1-2a) Attribution of the ¹H NMR Signals Used for the Quantification:

Example of the butadiene/2-ethylhexyl methacrylate and butadiene/n-octyl methacrylate copolymers: attribution of the ¹H NMR signals used for the quantification:

| | Number of | |
|---|---|---|
| δ ¹H (ppm) | protons | Attribution |
| 3.4 to 4.0 | 2 | CH₂—O at the alpha position of the ester |
| | | group of the 2-ethylhexyl methacrylate units |
| 3.6 to 4.2 | 2 | CH₂—O at the alpha position of the ester |
| | | group of the n-octyl methacrylate units |
| 4.6 to 4.9 | 2 | ethylenic CH₂ of the 1,2- (vinyl) units of |
| | | the butadiene part |
| 4.9 to 5.7 | 1 + 2 | ethylenic CH of the 1,2- unit of the butadiene |
| | | part and 2 ethylenic CH of the 1,4- unit of |
| | | the butadiene part. |

Example of a butadiene/glycidyl methacrylate copolymer: attribution of the ¹H NMR signals used for the quantification:

| | Number of | |
|---|---|---|
| δ ¹H (ppm) | protons | Attribution |
| 4.32/3.80/3.12/2.75/2.57 | 1/1/1/1/1 | CH₂—O at the alpha position of |
| | | the ether; CH and CH₂ of the |
| | | glycidyl of the glycidyl |
| | | methacrylate units |
| 4.6 to 4.9 | 2 | ethylenic CH₂ of the 1,2- units of |
| | | the butadiene part |
| 4.9 to 5.7 | 1 + 2 | ethylenic CH of the 1,2- unit of |
| | | the butadiene part and 2 |
| | | ethylenic CH of the 1,4- |
| | | unit of the butadiene part. |

### 1-3 Determination of the Macrostructure of the Elastomers by SEC Analysis:

The SEC (Size Exclusion Chromatography) technique is used, which makes it possible to separate macromolecules in solution according to their size through columns filled with a porous gel. The macromolecules are separated according to their hydrodynamic volume, the bulkiest being eluted first.

### SEC (PS Calibration):

SEC is coupled to a refractometer; it gives, in this case, relative information. Starting from commercial standard products, the various number-average molar masses (Mₙ) and weight-average molar masses (M_{w}) that characterize the distribution of the molar masses of the polymer may be determined and the polymolecularity index (PI=M_{w}/Mₙ) calculated via a Moore calibration. There is no specific treatment of the polymer sample before analysis. The latter is simply dissolved in the elution solvent at a concentration of approximately 1 g/l. The solution is then filtered through a filter with a porosity of 0.45 μm before injection.

The apparatus used is a Waters Alliance chromatographic line. The elution solvent is either tetrahydrofuran, or tetrahydrofuran+1 vol. % of diisopropylamine+1 vol. % of triethylamine, the flow rate is 0.7 ml/min, the temperature of the system is 35° C. and the analysis time is 90 min. A set of four WATERS columns (1 Styragel HMW7 column+1 Styragel HMW6E column+2 Styragel HT6E columns) is used. The volume of the solution polymer sample injected is 100 μl. The detector is a Waters 2414 differential refractometer and the software for making use of the chromatographic data is the Waters Empower system.

The average molar masses calculated are relative to a calibration curve produced from commercial polystyrene standards PSS READY CAL-KIT.

### Double Detection SEC (Universal Calibration):

SEC is an absolute method if it has double detection composed of a refractometer and a viscometer. In this case, the various number-average molar masses (Mₙ) and weight-average molar masses (M_{w}) are determined via a universal calibration. There is no specific treatment of the polymer sample before analysis. The latter is simply dissolved in the elution solvent at a concentration of approximately 1 g/l. The solution is then filtered through a filter with a porosity of 0.45 μm before injection.

The apparatus used is a Waters Alliance chromatographic line. The elution solvent is either tetrahydrofuran, or tetrahydrofuran+1 vol. % of diisopropylamine+1 vol. % of triethylamine, the flow rate is 0.7 ml/min, the temperature of the system is 35° C. and the analysis time is 90 min. A set of four WATERS columns (1 Styragel HMW7 column+1 Styragel HMW6E column+2 Styragel HT6E columns) is used. The volume of the solution polymer sample injected is 100 μl. The detector is a TDA 302 appliance from VISCOTEK, and is composed of a differential refractometer and of a viscometer. The data are processed with the OMNISEC software.

### 1-4 Determination of the Friction Coefficient and of the Grip Coefficient:

The friction coefficient was measured on a test specimen, the grip coefficient was measured on tires fitted to a trailer. In the tables of the examples, the friction coefficient and the grip coefficient are listed under the designations “μ laboratory” and “μ Trailer” respectively.

### Method for Measuring the Friction Coefficient (μ Laboratory):

The measurements of the dynamic friction coefficient were carried out according to a method identical to that described by L. Busse, A. Le Gal, and M. Küppel (Modelling of Dry and Wet Friction of Silica Filled Elastomers on Self-Affine Road Surfaces, Elastomere Friction, 2010, 51, μ 8). The test specimens were produced by moulding, then crosslinking of a square rubbery support (50 mm×50 mm) having a thickness of 6 mm. After closing the mould, the latter is placed in a press with heated platens at the temperature (typically 150° C.), and for the time necessary for the crosslinking of the material (typically several tens of minutes), at a pressure of 16 bar. The surface used to carry out these measurements is a core withdrawn from a real road surface made of bituminous concrete of BBTM type (Standard NF P 98-137). In order to prevent the phenomena of dewetting and the appearance of secondary grip forces between the ground and the material, the ground+test specimen system is immersed in a 5% aqueous solution of a surfactant (Sinnozon—CAS number: 25155-30-0). The temperature of the aqueous solution is regulated using a thermostatic bath. The test specimen is subjected to a sliding movement in translation parallel to the plane of the ground. The sliding velocity SV is set at 0.03 m/sec. The normal stress applied sₙ is 100 kPa. These conditions are described below by “wet ground conditions”. The tangential stress sₜ, opposed to the movement of the test specimen over the ground, is measured continuously. The ratio of the tangential stress sₜ to the normal stress sₙ gives the coefficient of dynamic friction μ. The values indicated in the examples are the dynamic friction coefficient values measured for an aqueous solution temperature of 20° C. and 40° C., obtained at steady state after stabilization of the value of the tangential stress sₜ. A value above that of the reference, arbitrarily set at 100, indicates an improved result.

### Method for Measuring the Grip Coefficient (μ Trailer):

The Trailer test is a grip test used for determining the grip coefficient (or maximum braking force coefficient) μ Trailer, which is the highest value of the dynamic braking force coefficient in real time, prior to wheel lockup, starting from a slippage of a tire/rim assembly (mounted on a dynamometer hub at 65 km/h) on wet ground.

This test is carried out under the conditions of the wet grip test method for C1 class tires described in (EU) Regulation No. 228/2011. It differs by the choice of the reference tire: the candidate tires are compared to the Primacy HP tire, chosen as control in the examples of the present patent application, and not to the reference tire described in (EU) Regulation No. 228/2011 and the characteristics of which are indicated in the standard ASTM F 2493-08 16 inches (SRTT16″).

The values indicated in the examples are the μ Trailer grip coefficients measured for the candidates relative to the μ Trailer grip coefficient of the Primacy HP tire chosen as reference, measured under the same conditions, in particular at the same temperature at 23° C. A value above that of the reference, arbitrarily set at 100, indicates an improved result.

### 1-5 Rolling Resistance of the Tires:

The rolling resistance is measured on a flywheel, according to the ISO 87-67 (1992) method. A value greater than that of the reference, arbitrarily set at 100, indicates an improved result, that is to say a lower rolling resistance.

### 1-6 Wet Grip of the Tires:

The tires are fitted to a motor vehicle of Renault make and Megane 1.6 RTE model, equipped with an ABS braking system and the distance required to go from 80 km/h to 10 km/h is measured during sudden braking on sprayed ground (asphalt concrete). The results are given for a given temperature, which is the temperature of the water on the sprayed ground. A value above that of the reference, arbitrarily set at 100, indicates an improved result, i.e. a shorter braking distance.

### 1-7 Dry Grip of the Tires:

The tires are fitted to a motor vehicle of Renault make and Megane 1.6 RTE model, equipped with an ABS braking system and the distance required to go from 100 km/h to 0 km/h is measured during sudden braking on dry ground (asphalt concrete). A value above that of the reference, arbitrarily set at 100, indicates an improved result, i.e. a shorter braking distance.

### 2—Preparation of the Elastomers:

### 2-1 Synthesis of Elastomer E1: 1,3-Butadiene/2-Ethylhexyl Methacrylate Copolymer:

The reaction takes place in a 100-litre reactor. 0.7 kg (5 phr) of sodium stearate are dissolved in 27 litres of demineralized water. 6.29 g of tert-dodecyl mercaptan (0.05 equivalent of transfer agent with respect to the potassium persulphate), 3.01 kg of butadiene and 11 kg of 2-ethylhexyl methacrylate are added to the reaction medium. The reactor is heated at 50° C. with a stirring speed of 80 rpm, before introducing 0.168 kg (1.2 phr) of potassium persulphate. After 95 minutes of polymerization reaction, 61% conversion of monomers to copolymer is achieved. The reaction is then stopped by addition of 0.42 kg (3 phr) of resorcinol. A mixture of antioxidants of 4,4′-methylenebis(2,6-tert-butylphenol) and N-(1,3-dimethylbutyl)-N′-phenyl-p-phenylenediamine (20 wt %/80 wt %) prepared in the melt state and diluted in water and surfactant (sodium stearate), (0.5 phr) is then added to the copolymer latex. The antioxidized latex is then transferred to a stripping column to which 0.2 phr of Foamaster antifoaming agent are added in order to prevent foaming of the emulsion during the stripping. The stripping step is carried out at 100° C. The stripped polymer solution is added slowly to a solution of aluminium sulphate (14 phr of destabilizing agent with respect to the polymer) in water while stirring at 100 rpm. Polymer particles are formed that rise to the surface as soon as the stirring is stopped. These particles are washed until the pH reaches a value of 7. The polymer particles are recovered and dried on a screw at a temperature above 100° C. 8.4 kg of copolymer based on butadiene and 2-ethylhexyl methacrylate are recovered with a volatiles content of less than 0.5%.

The copolymer obtained has the following characteristics:
Tg=−53° C.
Mn=254 100 g/mol (PS calibration) and PI=3.4
molar % (2-ethylhexyl methacrylate monomer unit)=45.5
molar % (butadiene monomer unit)=54.5

### 2-2 Synthesis of Elastomer E2: 1,3-Butadiene/Styrene Copolymer:

Anionic polymerization is carried out in a capped bottle with moderate stirring and under an inert nitrogen atmosphere. Before starting the polymerization, methylcyclohexane is introduced into the bottle. The bottle is capped and sparging with nitrogen is carried out for 10 minutes. The butadiene, the styrene and the polar additive (THF) are then injected into the bottle. The impurities are neutralized by metered addition of n-BuLi directly onto the mixture of monomer, solvent and optionally polar agent. The initiator solution (n-BuLi) is added to this neutralized mixture of solvent, butadiene and styrene. The temperature of the reaction medium is 50° C. At the end of polymerization, a solution of methanol in solution in methylcyclohexane is added to the living polymer in order to protonate the living chains. The polymer solution is subjected to an antioxidant treatment by addition of 0.2 part per hundred parts of elastomer (phr) of 4,4′-methylenebis(2,6-tert-butylphenol) and 0.2 part per hundred parts of elastomer (phr) of N-(1,3-dimethylbutyl)-N′-phenyl-p-phenylenediamine, then the polymer is dried by stoving at 60° C. for 1 day.

The copolymer obtained has the following characteristics:
Tg=−24° C.
Mn=125 000 g/mol (PS calibration) and PI=1.1
Weight % (styrene monomer unit)=26
Weight % (1,2-butadiene monomer unit)=58

### 2-3 Synthesis of Elastomer E3: Styrene/1,3-Butadiene/Glycidyl Methacrylate Terpolymer:

The reaction takes place in a 30-litre reactor. 0.1 kg (5 phr) of sodium stearate are dissolved in 17 litres of demineralized water. 0.9 g of tert-dodecyl mercaptan (0.05 equivalent of transfer agent with respect to the potassium persulphate), 0.270 kg of styrene, 1.50 kg of butadiene and 0.230 kg of glycidyl methacrylate are added to the reaction medium. The reactor is heated at 40° C. with a stirring speed of 190 rpm, before introducing 0.024 kg (1.2 phr) of potassium persulphate in solution in 1.2 l of water. After 380 minutes of polymerization reaction, 61% conversion of monomers to copolymer is achieved. The reaction is then stopped by addition of 0.02 kg (1 phr) of resorcinol. The latex is then transferred to a stripping column to which 0.2 phr of Foamaster antifoaming agent are added in order to prevent foaming of the emulsion during the stripping. The stripping step is carried out at 100° C. The stripped polymer solution is added slowly to a solution of aluminium sulphate (14 phr of destabilizing agent with respect to the polymer) in water while stirring at 100 rpm. Polymer particles are formed that rise to the surface as soon as the stirring is stopped. These particles are washed until the pH reaches a value of 7. The polymer particles are recovered and dried under vacuum at 60° C. 0.94 kg of copolymer based on butadiene and 2-ethylhexyl methacrylate are recovered with a volatiles content of less than 0.5%.

The copolymer obtained has the following characteristics:
Tg=−59° C.
Molar % (styrene monomer unit)=9
molar % (1,2-butadiene monomer unit)=86
molar % (glycidyl methacrylate monomer unit)=5

### 2-4 Synthesis of Elastomer E4: Glycidyl Methacrylate/n-Octyl Methacrylate Copolymer:

The monomers (n-octyl methacrylate, glycidyl methacrylate (GlyMA)), the initiator (tert-butyl peroxypivalate (TBPPI)) and the solvent (methyl ether ketone (MEK)) are introduced into a round-bottomed flask equipped with a condenser following the proportions indicated in the table below. Three vacuum/argon cycles are carried out, then the reaction medium is heated at 65° C., the polymerization is carried out in methyl ether ketone (MEK) having a solids content of 70% with an initiator content of 0.05%.

| Name/Ref. | MM | m (g) | n (mol) | % mol |
|---|---|---|---|---|
| Octyl methacrylate | 198.3 | 100.0 | 0.505 | 95.0 |
| GLYMA | 142.15 | 3.8 | 0.027 | 5.0 |
| TBPPI | 174 | 0.6 | 0.00027 | |
| MEK | | 44 | | |

The reaction is stopped when the medium becomes too viscous. The conversion is 61%. The polymer is dissolved in acetone, then precipitated in ethanol (elimination of the monomers).

The copolymer obtained has the following characteristics:
Tg very spread out from −120° C. to 0° C., measured at −53° C.
Mn=97 000 g/mol (PS calibration) and PI=2.4
molar % (n-octyl methacrylate monomer unit)=95
molar % (glycidyl methacrylate monomer unit)=5

### 2-5 Preparation of Elastomers E5 and E6: Poly(2-Ethylhexyl Methacrylate) and Poly(n-Octyl Methacrylate) Respectively:

Elastomers E5 and E6, respectively a poly(2-ethylhexyl methacrylate) and a poly(n-octyl methacrylate), are supplied by Scientific Polymer Products, Inc. in solution in toluene. These polymers were dried in an oven under vacuum and under nitrogen at 60° C. overnight. The characterization of the macrostructure of these polymers was carried out by double detection SEC (absolute method with universal calibration).

The poly(2-ethylhexyl methacrylate) (E5) has the following characteristics: Tg very spread out from −110° C. to 0° C., measured at approximately −50° C.
Mn=71 500 g/mol (universal calibration)
Mw=192 100 g/mol (universal calibration)
PI=2.69

The poly(n-octyl methacrylate) (E6) has the following characteristics: Tg very spread out from −110° C. to −20° C., measured at −59° C.
Mn=65 300 g/mol (universal calibration)
Mw=183 100 g/mol (universal calibration)
PI=2.8

### 3—Preparation of the Rubber Compositions:

The formulations (in phr) of the compositions C0 to C4 are described in Tables I, III and V.

Compositions C1, C4, C5 and C6 are in accordance with embodiments of the invention; compositions C0, C2, C3 and Cr are compositions not in accordance with the invention. Composition Cr corresponds to the vulcanized composition of the tread of a “Primacy HP” tire Tr taken as reference as regards braking on wet ground and on dry ground.

Compositions C1, C4, C5 and C6 all contain an elastomer which comprises at least 20 mol % of monomer units of a methacrylic acid ester. The respective elastomer matrices of compositions C1 and C4 consist of a single elastomer, respectively E1 and E4. The respective elastomer matrices of compositions C5 and C6 consist of a mixture of an SBR E2 and of the respective elastomer E5 and E6.

The sites of the elastomer matrix that are reactive with respect to the crosslinking system are borne:
by the 1,3-butadiene monomer units of elastomer E1 in composition C1;
by the glycidyl methacrylate monomer units of elastomer E4 in composition C4;
by the 1,3-butadiene monomer units of the SBR in compositions C5 and C6.

The crosslinking system for compositions C1, C5 and C6 is a vulcanization system, that of C4 is a diacid.

These compositions are manufactured in the following manner: the elastomers, the silica, the coupling agent, where appropriate the plasticizer(s), and also the various other ingredients, with the exception of the crosslinking system, are successively introduced into an internal mixer (final degree of filling: approximately 70% by volume), the initial vessel temperature of which is around 60° C. The crosslinking system for compositions C0, C1, C2, C5 and C6 consists of sulphur and a sulphenamide; that for compositions C4 and C3 is a diacid. Thermomechanical working (non-productive phase) is then carried out in one step, which lasts in total 5 min, until a maximum “dropping” temperature of 165° C. is reached.

The mixture thus obtained is recovered and cooled and then the crosslinking system is incorporated on a mixer (homofinisher) at 23° C., everything being mixed (productive phase) for an appropriate time (for example between 5 and 12 min).

The compositions thus obtained are then calendered, either in the form of slabs (having a thickness ranging from 2 to 3 mm) or thin sheets of rubber, for the measurement of their physical or mechanical properties, or in the form of profiled elements that can be used directly, after cutting and/or assembling to the desired dimensions, for example as semi-finished products for tires, in particular for treads.

### 4—Properties of the Rubber Compositions and of the Tires:

The properties of compositions C0 to C7 are given relative to a base 100 with respect to Cr in Tables II, IV and VI.

4-1 Example in which the Sites of the Elastomer Matrix that are Reactive with Respect to the Crosslinking System are Borne by Elastomer A (in this Case E1): (Tables I and II)

Compositions C0 and C1 are used as treads for radial carcass passenger vehicle tires, denoted respectively by T0 (tire not in accordance with the invention) and T1 (tire in accordance with embodiments of the invention), having dimensions of 205/55R16 that are conventionally manufactured and are in all respects identical to the “Primacy HP” tire, except for the rubber compositions forming their tread. The “Primacy HP” tire is a reference tire as regards wet braking and dry braking. The performances of T1 are compared to that of the “Primacy HP” reference tire Tr relative to a base 100, the results being recorded in Table II.

The tire T1 has a wet performance index of 129 at 25° C., which corresponds to a significantly shortened braking distance compared to the tire Tr. This great improvement in wet braking performance is not achieved at the expense of the dry braking performance. Indeed, the performance index of T1 is even slightly improved with respect to Tr. Furthermore, an increase in the rolling resistance which is only 5% is surprisingly observed, considering the improvement in the braking performances.

The friction coefficient of a test specimen consisting of composition C1 and measured at 20° C., is increased by 29% relative to that of composition Cr. The measurement of the grip coefficient carried out on the tire at 23° C. gives a comparable result, namely an improvement of 28%. These friction coefficient and grip coefficient results are in very good agreement with the gain of almost 30% measured in wet braking.

It is noted that the method for measuring the μ laboratory friction coefficient of a rubber composition produced on a test specimen is here representative of the wet grip performance of a tire for which the tread would be made from this rubber composition. It makes it possible to obtain a good descriptor of the wet braking performance of the tread materials.

On the other hand, regarding the example not in accordance with the invention (respectively the composition C0 and the tire T0), neither an improvement in the friction coefficient nor an improvement in the grip coefficient with respect to the reference (respectively Cr and Tr) is observed: the values of the coefficients remain lower than those of the reference.

These results unexpectedly demonstrate that the incorporation of at least 20 mol % of 2-ethylhexyl methacrylate monomer unit into a diene elastomer makes it possible to very significantly improve the wet grip performances of a tire of which the tread contains this elastomer, while retaining a good performance compromise between dry grip and rolling resistance.

4-2 Example in which the Sites of the Elastomer Matrix that are Reactive with Respect to the Crosslinking System are Borne by Elastomer A (in this Case E3 and E4): (Tables III and IV)

Composition C4 is in accordance with embodiments of the invention, since it contains the elastomer E4 comprising at least 20 mol % of n-octyl methacrylate monomer unit and also 5 mol % of glycidyl methacrylate monomer unit, monomer units that are reactive with respect to the crosslinking system. On the other hand, compositions C2 and C3 are not in accordance with the invention, since the elastomer E3 used in C2 and in C3 is a styrene/butadiene/glycidyl methacrylate terpolymer, the molar content of glycidyl methacrylate monomer unit being 5%.

Compositions C2, C3 and C4 are used to form test specimens for measuring the friction coefficient.

The friction coefficients of compositions C2 and C3 not in accordance with the invention are very similar and remain lower than that of the reference Cr.

Only the friction coefficient of composition C4 is much higher than that of the reference, 40% higher at 20° C., which results, compared to the reference tire Tr, in a wet grip performance that is much higher for the tire of which the tread is formed from composition C4.

4-3 Example in which the Sites of the Elastomer Matrix that are Reactive with Respect to the Crosslinking System are Borne by Elastomer B (in this Case an SBR): (Tables V and VI)

Compositions C5 and C6 are both in accordance with embodiments of the invention. Elastomer A is respectively elastomer E5, namely a poly(2-ethylhexyl methacrylate) in composition C5 and elastomer E6, namely a poly(n-octyl methacrylate) in composition C6. The monomer units that are reactive with respect to the crosslinking system are those present in elastomer E2, SBR. Composition C5 differs from composition C6 in that it contains a plasticizer. The silica content of composition C5 has been consequently adjusted in order to achieve a volume fraction of reinforcing filler identical to that of C6, namely 25%. For each of the compositions, the silane content and the diphenylguanidine content have been adjusted as a function of the silica content present in the rubber composition.

In summary, compositions C5 and C6 differ only by the nature of the elastomer A and the presence of a plasticizer.

The respective friction coefficient of compositions C5 and C6 is much higher than that of the reference, which results in a wet grip performance that is much higher for the tires of which the tread is formed respectively from compositions C5 and C6 compared to the reference tire Tr.

In summary, the examples show that the introduction of the elastomers E1, E4, E5 and E6 into tread compositions makes it possible to significantly improve the wet grip performance compared to the “Primacy HP” tire, reference tire as regards wet grip.

TABLE I

| | C0 | C1 |
|---|---|---|
| Elastomer (1) | 100 | — |
| Elastomer E1 (2) | — | 100 |
| Silica (3) | 81 | 81 |
| Carbon black N234 | 4 | 4 |
| Plasticizer (4) | 15 | 15 |
| Antioxidant (5) | 2 | 2 |
| Antiozone wax | 1.5 | 1.5 |
| Silane (6) | 6.5 | 6.5 |
| Plasticizing resin (7) | 15 | 15 |
| Stearic acid | 2 | 2 |
| DPG (8) | 1.5 | 1.5 |
| ZnO | 3 | 3 |
| Sulphenamide (9) | 1.5 | 1.5 |
| Sulphur | 1.5 | 1.5 |

(1) SBR 1500, Tg −50° C.
(2) 1,3-butadiene/2-ethylhexyl methacrylate copolymer (see section II.2-1)
(3) Silica: Zeosil 1165 MP from Rhodia (HDS type)
(4) Tris(2-ethylhexyl)phosphate
(5) N-(1,3-dimethylbutyl)-N′-phenyl-p-phenylenediamine, from Flexsys
(6) TESPT (Si69 from Degussa)
(7) Polylimonene resin, Dercolyte L120 from DRT
(8) Diphenylguanidine (Perkacit DPG from Flexsys)
(9) N-cyclohexyl-2-benzothiazolesulphenamide (Santocure CBS from Flexsys)

TABLE II

| | | | Reference Tr |
|---|---|---|---|
| Tire | P0 | P1 | (Primacy HP) |
| Composition No.: | C0 | C1 | Cr |
| Rolling resistance | 100 | 95 | 100 |
| Wet braking 25° C. | Not | 129 | 100 |
| | measured | | |
| Dry braking | Not | 103 | 100 |
| | measured | | |
| μ Trailer (23° C.) | 98 | 128 | 100 |
| μ laboratory (20° C.) | 93 | 129 | 100 |
| μ laboratory (40° C.) | 95 | 127 | 100 |

TABLE III

| | C2 | C3 | C4 |
|---|---|---|---|
| Elastomer E3 (1) | 100 | 100 | — |
| Elastomer E4 (2) | — | — | 100 |
| Silica (3) | 85 | 85 | 85 |
| Plasticizer (4) | 30 | 30 | 30 |
| Silane (5) | 6.5 | 6.5 | 6.5 |
| Alkoxysilane (6) | 4.3 | 4.3 | 4.3 |
| Stearic acid | 2 | — | — |
| ZnO | 2.5 | — | — |
| Sulphenamide (7) | 1.5 | — | — |
| Sulphur | 1.5 | — | — |
| Diacid (8) | — | 1 | 1 |

(1) Styrene/1,3-butadiene/glycidyl methacrylate terpolymer (see section II.2-3)
(2) Glycidyl methacrylate/n-octyl methacrylate copolymer (see section II.2-4)
(3) Silica: Zeosil 1165 MP from Rhodia (HDS type)
(4) Tris(2-ethylhexyl)phosphate
(5) TESPT (Si69 from Degussa)
(6) Dynasylan Octeo from Degussa
(7) N-cyclohexyl-2-benzothiazolesulphenamide (Santocure CBS from Flexsys)
(8) Dodecanedioic acid from Sigma-Aldrich

TABLE IV

| Composition No.: | C2 | C3 | C4 | Cr |
|---|---|---|---|---|
| μ laboratory (20° C.) | 80 | 80 | 140 | 100 |
| μ laboratory (40° C.) | 72 | 76 | 136 | 100 |

TABLE V

| | C5 | C6 |
|---|---|---|
| Elastomer E2 (1) | 40 | 40 |
| Elastomer E5 (2) | 60 | — |
| Elastomer E6 (3) | — | 60 |
| Silica (4) | 104 | 78 |
| Carbon black N234 | 5 | 4 |
| Plasticizer (5) | 34 | — |
| Antioxidant (6) | 2 | 2 |
| Antiozone wax | 1.5 | 1.5 |
| Silane (7) | 4.7 | 3.6 |
| Stearic acid | 2 | 2 |
| DPG (8) | 1.5 | 1.4 |
| ZnO | 3 | 3 |
| Sulphenamide (9) | 1.5 | 1.5 |
| Sulphur | 1.5 | 1.5 |
| Volume fraction of reinforcing filler | 25% | 25% |

(1) SBR with 26% of styrene units and 58% of 1,2- units of the butadiene part, Tg −25° C. (see section II.2-2)
(2) Poly(2-ethylhexyl methacrylate), from SP2 sold in solution (see section II.2-5)
(3) Poly(n-octyl methacrylate), from SP2 sold in solution (see section II.2-5)
(4) Silica: Zeosil 1165 MP from Rhodia (HDS type)
(5) Tris(2-ethylhexyl)phosphate
(6) N-(1,3-dimethylbutyl)-N′-phenyl-p-phenylenediamine, from Flexsys
(7) TESPT (Si69 from Degussa)
(8) Diphenylguanidine (Perkacit DPG from Flexsys)
(9) N-cyclohexyl-2-benzothiazolesulphenamide (Santocure CBS from Flexsys)

TABLE VI

| Composition No.: | C5 | C6 | Cr |
|---|---|---|---|
| m laboratory (40° C.) | 115 | 115 | 100 |

1. A rubber composition based on:
a reinforcing filler,
a crosslinking system,
an elastomer matrix that is reactive with respect to the crosslinking system, which elastomer matrix comprises an elastomer A comprising monomer units of a first methacrylic acid ester which represent at least 20 mol % of the monomer units of the elastomer A, and
if the elastomer A is a polymer of several monomers, the elastomer A is a statistical copolymer.

2. A rubber composition according to claim 1, in which the monomer units of the first methacrylic acid ester represent at least 30 mol % of the monomer units of the elastomer A.

3. A rubber composition according to claim 1, in which the first methacrylic acid ester corresponds to the formula (I)
CH₂═C(CH₃)—COO—Z (I)
where Z is a carbon-based chain comprising at least 2 carbon atoms, optionally substituted and optionally interrupted by one or more heteroatoms.

4. A rubber composition according to claim 3, in which Z comprises from 2 to 20 carbon atoms.

5. A rubber composition according to claim 3, in which Z is a hydrocarbon-based chain.

6. A rubber composition according to claim 5, in which Z is an alkyl radical.

7. A rubber composition according to claim 1, in which the first methacrylic acid ester is different from a methacrylic acid ester comprising one or more epoxide functions.

8. A rubber composition according to claim 1, in which the first methacrylic acid ester is an aliphatic compound.

9. A rubber composition according to claim 1, in which the elastomer matrix comprises monomer units that are reactive with respect to the crosslinking system.

10. A rubber composition according to claim 9, in which the elastomer matrix comprises a second elastomer, elastomer B, which comprises monomer units that are reactive with respect to the crosslinking system.

11. A rubber composition according to claim 10, in which the elastomer B is a diene elastomer.

12. A rubber composition according to claim 11, in which the elastomer B is an essentially unsaturated diene elastomer selected from polybutadienes, polyisoprenes, butadiene copolymers, isoprene copolymers and mixtures thereof.

13. A rubber composition according to claim 10, in which the elastomer matrix consists of the elastomer A and of the elastomer B.

14. A rubber composition according to claim 10, in which the monomer units of the first methacrylic acid ester present in the elastomer A represent 100 mol % of the monomer units of the elastomer A.

15. A rubber composition according to claim 14, in which the elastomer A is a homopolymer of 2-ethylhexyl methacrylate, a homopolymer of n-octyl methacrylate, a homopolymer of isodecyl methacrylate or a homopolymer of n-tridecyl methacrylate.

16. A rubber composition according to claim 9, in which the elastomer A comprises monomer units that are reactive with respect to the crosslinking system.

17. A rubber composition according to claim 16, in which the elastomer A comprises monomer units of a second monomer, which monomer units of the second monomer are reactive with respect to the crosslinking system.

18. A rubber composition according to claim 17, in which the monomer units of the second monomer contain at least one NH₂, OH, imide, carbonate or epoxy group or a carbon-carbon double bond.

19. A rubber composition according to claim 18, in which the second monomer of the elastomer A is a 1,3-diene.

20. A rubber composition according to claim 19, in which the second monomer of the elastomer A is 1,3-butadiene or isoprene.

21. A rubber composition according to claim 17, in which the second monomer of the elastomer A is a second methacrylic acid ester.

22. A rubber composition according to claim 21, in which the second methacrylic acid ester is dicyclopentadienyloxyethyl methacrylate.

23. A rubber composition according to claim 21, in which the second methacrylic acid ester is glycidyl methacrylate.

24. A rubber composition according to claim 21, in which the second methacrylic acid ester is glycerol carbonate methacrylate.

25. A rubber composition according to claim 17, in which the elastomer A is a copolymer of the first methacrylic acid ester and of the second monomer.

26. A rubber composition according to claim 1, in which the reinforcing filler comprises an inorganic filler.

27. A rubber composition according to claim 26, in which the inorganic filler is a silica.

28. A rubber composition according to claim 26, which comprises a coupling agent.

29. A rubber composition according to claim 1, in which the reinforcing filler comprises a carbon black.

30. A semi-finished product made of rubber comprising a ion according to claim 1.

31. A semi-finished product according to claim 30, made of rubber, it wherein the semi-finished product is a tire tread.

32. A tire comprising a semi-finished product according to claim 30.

33. A process for manufacturing the rubber composition according to claim 1, which comprises the following steps:
thermomechanically kneading the elastomer matrix, the reinforcing filler, where appropriate the coupling agent, where appropriate the plasticizing system, and the other additives of the rubber composition with the exception of the crosslinking system, until a maximum temperature of between 110° C. and 190° C. is reached;
cooling the combined mixture to a temperature of less than 100° C.;
subsequently incorporating the crosslinking system;
kneading the combined mixture including the crosslinking system up to a maximum temperature of less than 110° C., in order to obtain the rubber composition.

34. A process for manufacturing the tire according to claim 32, which comprises the following steps:
thermomechanically kneading the elastomer matrix, the reinforcing filler, where appropriate the coupling agent, where appropriate the plasticizing system, and the other additives of the rubber composition with the exception of the crosslinking system, until a maximum temperature of between 110° C. and 190° C. is reached;
cooling the combined mixture to a temperature of less than 100° C.;
subsequently incorporating the crosslinking system;
kneading the combined mixture including the cross-linking system up to a maximum temperature of less than 110° C., in order to obtain the rubber composition,
calendering or extruding the rubber composition.

35. A rubber composition according to claim 28, wherein the coupling agent is an organosilane.
